(19) United States
(12) Patent Application Publication
(10) Pub. No.: US 2014/0098034 A1
(43) Pub. Date: Apr. 10, 2014

(54) MULTI-FUNCTION HAND HELD DEVICE

(71) Applicants: Michael Hack, Princeton, NJ (US); Ruiqing Ma, Morristown, NJ (US); Emory Krall, Philadelphia, PA (US)

(72) Inventors: Michael Hack, Princeton, NJ (US); Ruiqing Ma, Morristown, NJ (US); Emory Krall, Philadelphia, PA (US)

(21) Appl. No.: 13/648,904

(22) Filed: Oct. 10, 2012

(51) Int. Cl. G09G 3/32; G06F 3/041; G09G 3/04

(52) U.S. Cl. 345/173; 345/33; 345/82

(57) ABSTRACT

A device is provided that includes a display that is switchable between a collapsed state and an extended state. In the collapsed state, the display is approximately the size of a smartphone. The device may be unfolded or unrolled to the extended state, which is approximately the size of a tablet or three times the size of a smartphone. The device may be held and operated with one hand in the collapsed state while the extended state may require two hands to hold or operate. The device may include a housing affixed to a flexible display. The housing may be used to incorporate rigid electronics or a battery into the device.

### PRIORITY

The claimed invention was made by, on behalf of, and/or in connection with one or more of the following parties to a joint university corporation research agreement: Regents of the University of Michigan, Princeton University, The University of Southern California, and the Universal Display Corporation. The agreement was in effect on and before the date the claimed invention was made, and the claimed invention was made as a result of activities undertaken within the scope of the agreement.

### FIELD OF THE INVENTION

The present invention relates to organic light emitting devices with flexible displays and, more specifically, to OLED devices having flexible displays that are usable in multiple configurations.

### BACKGROUND

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety.

One application for phosphorescent emissive molecules is a full color display. Industry standards for such a display call for pixels adapted to emit particular colors, referred to as “saturated” colors. In particular, these standards call for saturated red, green, and blue pixels. Color may be measured using CIE coordinates, which are well known to the art.

One example of a green emissive molecule is tris(2-phenylpyridine)iridium, denoted Ir(ppy)3, which has the following structure:

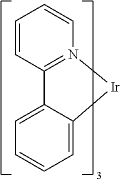

In this, and later figures herein, we depict the dative bond from nitrogen to metal (here, Ir) as a straight line.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

As used herein, “top” means furthest away from the substrate, while “bottom” means closest to the substrate. Where a first layer is described as “disposed over” a second layer, the first layer is disposed further away from substrate. There may be other layers between the first and second layer, unless it is specified that the first layer is “in contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

A ligand may be referred to as “photoactive” when it is believed that the ligand directly contributes to the photoactive properties of an emissive material. A ligand may be referred to as “ancillary” when it is believed that the ligand does not contribute to the photoactive properties of an emissive material, although an ancillary ligand may alter the properties of a photoactive ligand.

As used herein, and as would be generally understood by one skilled in the art, a first “Highest Occupied Molecular Orbital” (HOMO) or “Lowest Unoccupied Molecular Orbital” (LUMO) energy level is “greater than” or “higher than” a second HOMO or LUMO energy level if the first energy level is closer to the vacuum energy level. Since ionization potentials (IP) are measured as a negative energy relative to a vacuum level, a higher HOMO energy level corresponds to an IP having a smaller absolute value (an IP that is less negative). Similarly, a higher LUMO energy level corresponds to an electron affinity (EA) having a smaller absolute value (an EA that is less negative). On a conventional energy level diagram, with the vacuum level at the top, the LUMO energy level of a material is higher than the HOMO energy level of the same material. A “higher” HOMO or LUMO energy level appears closer to the top of such a diagram than a “lower” HOMO or LUMO energy level.

As used herein, and as would be generally understood by one skilled in the art, a first work function is “greater than” or “higher than” a second work function if the first work function has a higher absolute value. Because work functions are generally measured as negative numbers relative to vacuum level, this means that a “higher” work function is more negative. On a conventional energy level diagram, with the vacuum level at the top, a “higher” work function is illustrated as further away from the vacuum level in the downward direction. Thus, the definitions of HOMO and LUMO energy levels follow a different convention than work functions.

More details on OLEDs, and the definitions described above, can be found in U.S. Pat. No. 7,279,704, which is incorporated herein by reference in its entirety.

### SUMMARY OF THE INVENTION

A light emitting device is provided that includes a display with an extendable state and a collapsed state. The display may be flexible, rollable, or touch sensitive. The device may include an active matrix backplane. The flexile display may include be an OLED display, such as a phosphorescent OLED display, and may include a thin film encapsulation layer disposed over or under the OLED. The display may have a minimum resolution of 160 dpi, 200 dpi, 300 dpi, 400 dpi, or more. The device may include a wireless transmitter and/or it may be a component of a cellular telephone or similar device. It may have a second display that is physically distinct from the flexible display. In the extended state, the flexible display may be addressable to provide an extension of the second display. The flexible display may have a first viewable area when it is placed in the extended state and a second viewable area when it is placed in the collapsed state. The second viewable area may be smaller than the first viewable area, and/or the first viewable area may include the second viewable area.

The collapsed state may refer to a form factor similar to that of a smartphone or other arrangement that is capable of being held and operated with a single hand of a user. The second viewable area may be touchable by the thumb of a user when the device is held in the user's hand. The flexible display may be substantially U-shaped in the collapsed state with a top side and a bottom side. The top side may emit light and the bottom side may be disabled when the device is in the U-shape. The extended state may refer to a form factor of a tablet. In the extended state, the device may be configured to held and operated with two hands of a user. The housing responsible for the collapsed or extended state may be partially covered by the flexible display when the device is in the collapsed state. In the extended state, a portion of the housing may be exposed, that is, the flexible display may not cover it.

A sensor may detect or indicate the configuration of the device. The indication may be provided to the processor which may change the orientation of an image displayed on the device based upon the detected change in the configuration of the device. In an embodiment, a display state switch may indicate the state of the display. The switch may respond to rotation of the U-shaped flexible display in a horizontal axis and indicate to a processor to flow flexible display data from the top side of the U-shaped flexible display toward the bottom side of the U-shaped flexible display as the U-shaped flexible display is rotated. The switch may respond to rotation of the U-shaped flexible display in a vertical axis and indicate to the processor to switch the active flexible display from the top side of the U-shaped to the bottom side as the U-shaped flexible display is rotated.

### BRIEF DESCRIPTION OF THE DRAWINGS

FIG. 1 shows an organic light emitting device.

FIG. 2 shows an inverted organic light emitting device that does not have a separate electron transport layer.

FIG. 3A shows an example of a tri-folded device, such as a smartphone, representing the collapsed state of the device as disclosed herein.

FIG. 3B shows an example of the extended state of a tri-folded device as disclosed herein, now in a tablet like configuration approximately three times the size of the device shown in FIG. 3A.

FIG. 4A shows a tri-folded configuration of a display that may be provided as disclosed herein.

FIG. 4B shows some a “C-shaped” configuration of a display that may be provided as disclosed herein.

FIG. 4C shows a bi-folded configuration of a display that may be provided as disclosed herein.

FIG. 4D shows an “S-shaped” configuration of a display that may be provided as disclosed herein.

### DETAILED DESCRIPTION

Generally, an OLED comprises at least one organic layer disposed between and electrically connected to an anode and a cathode. When a current is applied, the anode injects holes and the cathode injects electrons into the organic layer(s). The injected holes and electrons each migrate toward the oppositely charged electrode. When an electron and hole localize on the same molecule, an “exciton,” which is a localized electron-hole pair having an excited energy state, is formed. Light is emitted when the exciton relaxes via a photoemissive mechanism. In some cases, the exciton may be localized on an excimer or an exciplex. Non-radiative mechanisms, such as thermal relaxation, may also occur, but are generally considered undesirable.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 3, 4-6 (1999) (“Baldo-II”), which are incorporated by reference in their entireties. Phosphorescence is described in more detail in U.S. Pat. No. 7,279,704 at cols. 5-6, which are incorporated by reference.

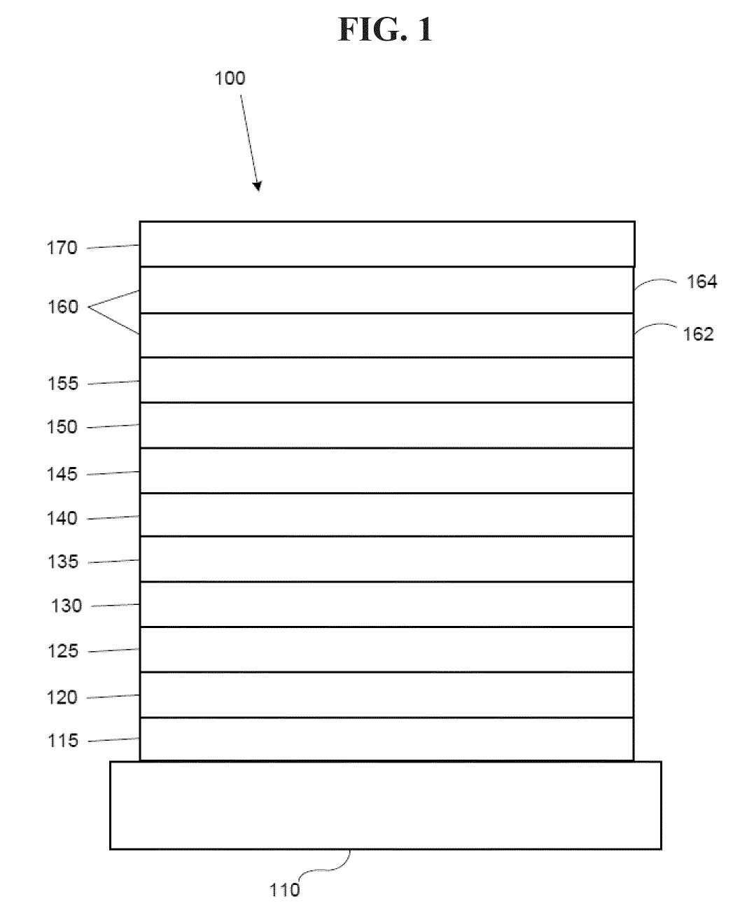

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, a cathode 160, and a barrier layer 170. Cathode 160 is a compound cathode having a first conductive layer 162 and a second conductive layer 164. Device 100 may be fabricated by depositing the layers described, in order. The properties and functions of these various layers, as well as example materials, are described in more detail in U.S. Pat. No. 7,279,704 at cols. 6-10, which are incorporated by reference.

More examples for each of these layers are available. For example, a flexible and transparent substrate-anode combination is disclosed in U.S. Pat. No. 5,844,363, which is incorporated by reference in its entirety. An example of a p-doped hole transport layer is m-MTDATA doped with F₄-TCNQ at a molar ratio of 50:1, as disclosed in U.S. Patent Application Publication No. 2003/0230980, which is incorporated by reference in its entirety. Examples of emissive and host materials are disclosed in U.S. Pat. No. 6,303,238 to Thompson et al., which is incorporated by reference in its entirety. An example of an n-doped electron transport layer is BPhen doped with Li at a molar ratio of 1:1, as disclosed in U.S. Patent Application Publication No. 2003/0230980, which is incorporated by reference in its entirety. U.S. Pat. Nos. 5,703,436 and 5,707,745, which are incorporated by reference in their entireties, disclose examples of cathodes including compound cathodes having a thin layer of metal such as Mg:Ag with an overlying transparent, electrically-conductive, sputter-deposited ITO layer. The theory and use of blocking layers is described in more detail in U.S. Pat. No. 6,097,147 and U.S. Patent Application Publication No. 2003/0230980, which are incorporated by reference in their entireties. Examples of injection layers are provided in U.S. Patent Application Publication No. 2004/0174116, which is incorporated by reference in its entirety. A description of protective layers may be found in U.S. Patent Application Publication No. 2004/0174116, which is incorporated by reference in its entirety.

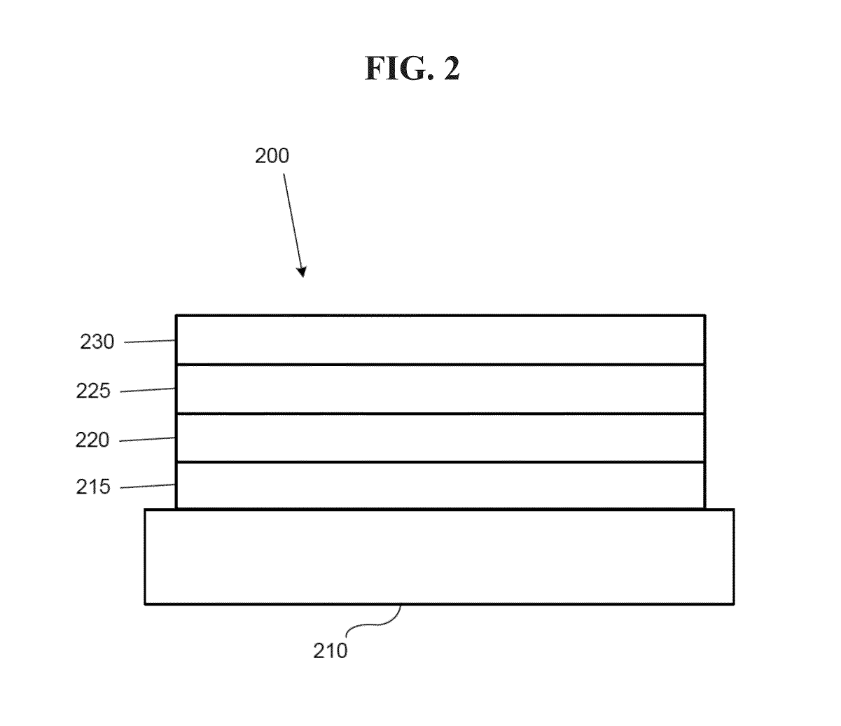

FIG. 2 shows an inverted OLED 200. The device includes a substrate 210, a cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that embodiments of the invention may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one embodiment, an OLED may be described as having an “organic layer” disposed between a cathode and an anode. This organic layer may comprise a single layer, or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190 to Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

Unless otherwise specified, any of the layers of the various embodiments may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. patent application Ser. No. 10/233,470, which is incorporated by reference in its entirety. Other suitable deposition methods include spin coating and other solution based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as ink jet and OVJD. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processibility than those having symmetric structures, because asymmetric materials may have a lower tendency to recrystallize. Dendrimer substituents may be used to enhance the ability of small molecules to undergo solution processing.

Devices fabricated in accordance with embodiments of the present invention may further optionally comprise a barrier layer. One purpose of the barrier layer is to protect the electrodes and organic layers from damaging exposure to harmful species in the environment including moisture, vapor and/or gases, etc. The barrier layer may be deposited over, under or next to a substrate, an electrode, or over any other parts of a device including an edge. The barrier layer may comprise a single layer, or multiple layers. The barrier layer may be formed by various known chemical vapor deposition techniques and may include compositions having a single phase as well as compositions having multiple phases. Any suitable material or combination of materials may be used for the barrier layer. The barrier layer may incorporate an inorganic or an organic compound or both. The preferred barrier layer comprises a mixture of a polymeric material and a non-polymeric material as described in U.S. Pat. No. 7,968,146, PCT Pat. Application Nos. PCT/US2007/023098 and PCT/US2009/042829, which are herein incorporated by reference in their entireties. To be considered a “mixture”, the aforesaid polymeric and non-polymeric materials comprising the barrier layer should be deposited under the same reaction conditions and/or at the same time. The weight ratio of polymeric to non-polymeric material may be in the range of 95:5 to 5:95. The polymeric material and the non-polymeric material may be created from the same precursor material. In one example, the mixture of a polymeric material and a non-polymeric material consists essentially of polymeric silicon and inorganic silicon.

Devices fabricated in accordance with embodiments of the invention may be incorporated into a wide variety of consumer products, including flat panel displays, computer monitors, medical monitors, televisions, billboards, lights for interior or exterior illumination and/or signaling, heads up displays, fully transparent displays, flexible displays, laser printers, telephones, cell phones, personal digital assistants (PDAs), laptop computers, digital cameras, camcorders, viewfinders, micro-displays, vehicles, a large area wall, theater or stadium screen, or a sign. Various control mechanisms may be used to control devices fabricated in accordance with the present invention, including passive matrix and active matrix. Many of the devices are intended for use in a temperature range comfortable to humans, such as 18 degrees C. to 30 degrees C., and more preferably at room temperature (20-25 degrees C.).

The materials and structures described herein may have applications in devices other than OLEDs. For example, other optoelectronic devices such as organic solar cells and organic photodetectors may employ the materials and structures. More generally, organic devices, such as organic transistors, may employ the materials and structures.

The terms halo, halogen, alkyl, cycloalkyl, alkenyl, alkynyl, arylkyl, heterocyclic group, aryl, aromatic group, and heteroaryl are known to the art, and are defined in U.S. Pat. No. 7,279,704 at cols. 31-32, which are incorporated herein by reference.

An organic light emitting device is provided. The device may include an anode, a cathode, and an organic emissive layer disposed between the anode and the cathode. The organic emissive layer may include a host and a phosphorescent dopant.

Thin film deposition processes can be used for depositing pixels onto a collapsible substrate to form a collapsible display. Preferably, the display may be fabricated on a flexible substrate, such as plastic or thin metal foil.

Active-matrix backplanes that are compatible with plastic substrates can be fabricated, and deposited onto the flexible substrate. The pixels can then be deposited thereon. Though active-matrix displays are preferred, it should be understood that passive-matrix displays can also be used in accordance with the principles of the invention. Active-matrix displays typically use transistors to keep their diodes in an on or off state. Passive-matrix displays, on the other hand, apply current to the diodes at a specific refresh rate to maintain an image.

OLED display technology may be desirable for use on such flexible substrates because of, among other reasons, its very low substrate temperature during deposition, as well as its high brightness at low power levels. Small molecule OLEDs can be used, such as described in U.S. Pat. No. 5,844,363, for example, which is incorporated herein by reference in its entirety. Encapsulation to prevent moisture and oxygen from permeating through the plastic films and degrading the OLED performance is also preferably provided, for example, such as disclosed on U.S. Pat. No. 5,771,562.

In an embodiment, a device is provided that includes a display having an extended state and a collapsed state. The display may have a first viewable area in the extended state and a second viewable area in the collapsed state, which typically is not larger than the first viewable area. The device may have various configurations, and for a particular configuration the display may be configurable between the extended and collapsed state. For example, the display may be a rollable or partially-rollable display that extends outward from a housing. In the collapsed state, part of the display may be visible, such as adjacent to a portion of the housing. The rollable display may be unrolled from the housing to place the display in the extended state, in which a larger portion of the display is visible. As another example, the device as a whole may be bent, folded, curved, or otherwise deformed to alternate between the extended and collapsed state. For example, a relatively large display such as a tablet- or laptop-sized display may be folded, rolled, bent, curved, or otherwise collapsed to obtain a smaller configuration, such as one about the size of a palmtop computer, smartphone, mini- or micro-tablet device, or the like. As described in further detail herein, the display may be arranged to be partially or entirely usable when in the collapsed state, or a portion of the display may be deactivated, occluded, or otherwise not directly viewable by a user.

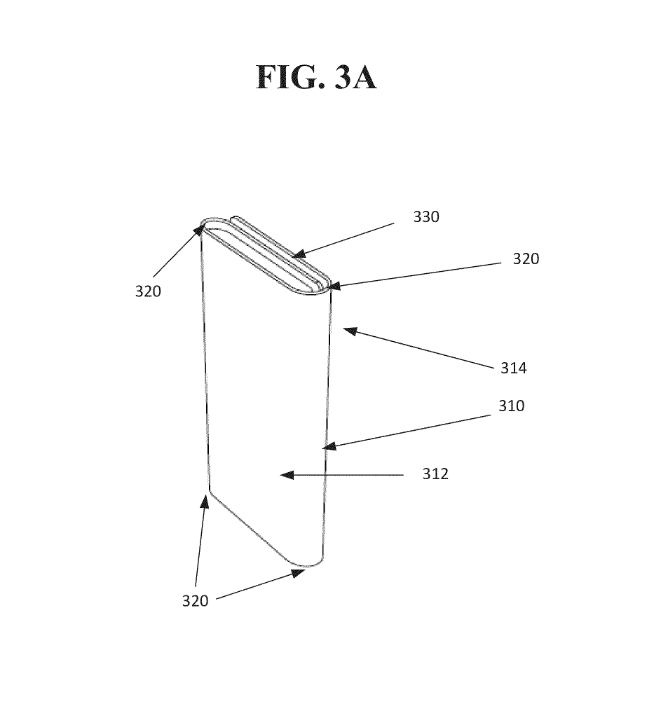

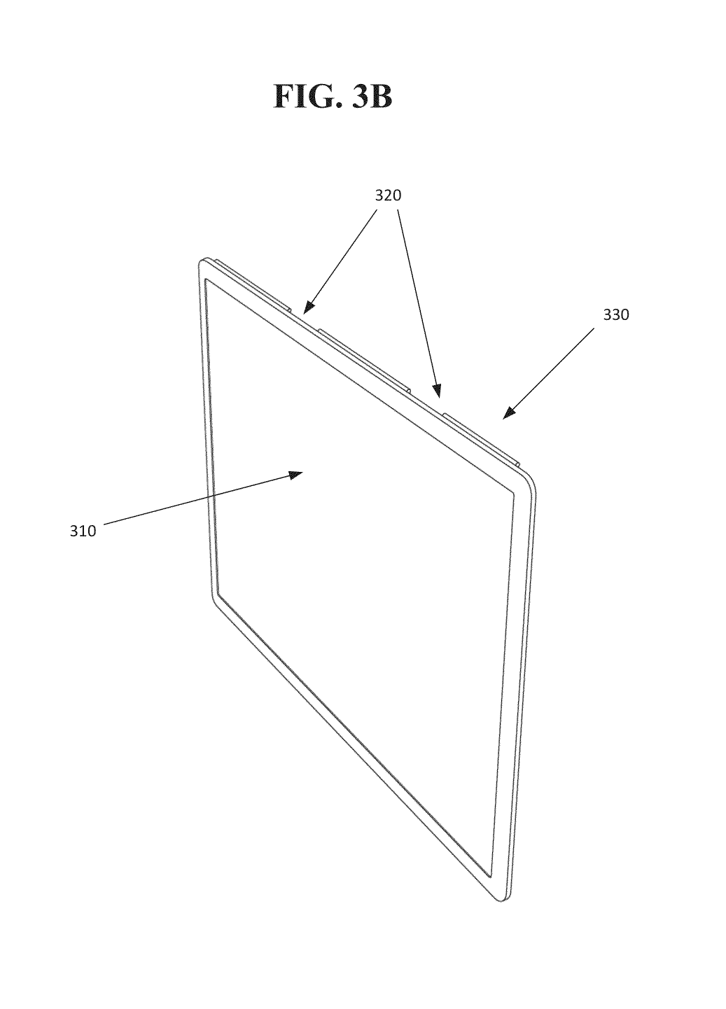

FIG. 3A shows an example configuration of a device that can be placed in a “tri-folded” display configuration. The display 310 may be flexible through-out, or it may be flexible only where hinges 320 are located or where the device is otherwise expected to bend, with the remainder of the display 310 being rigid. A black frame or housing 330 is shown on the top and bottom of the display 310. The housing 330 may be utilized to support the flexible display 310 in one or more configurations. For example, the housing 330 may be a frame that acts as a surface for a user to grasp the device. The housing 330 may incorporate or be used to hold electronics, a battery, or an antenna. The housing may include multiple segments or portions, each of which may support or contain a portion of the display. For example, referring to the tri-folded configuration in FIG. 3A, the housing 330 may include three or more portions, each of which is connected to and provides support to a portion of the flexible display.

The housing 330 may be completely covered by the flexible display 310 in some configurations. It may have hinges 320 on the top and/or the bottom of the housing to allow the device to be configured in the tri-folded shape shown in FIG. 3A. The hinges 320 may limit the degree of rotation on the screen 310, for example to prevent the device from folding in the opposite directions from those shown. Similarly, the segments of the device or the hinges may be lockable at different positions to conform the flexible display 310 into different shapes. Hinges 320 may be mechanical and released by sufficient force. As another example, the hinges 320 may be piezoelectrical or other configurations that respond to an electrical signal to configure or maintain the hinges, and thus the device, in a chosen shape. A skilled artisan will know that many different hinges 320 may be applied to the device disclosed herein to create a display 310 capable of existing in an extended state and a collapsed state. The housing 330 may also contain standoffs or be constructed of a nonabrasive material, such as plastic or rubber, to avoid scratching the surface of the display 310 that is folded to the inner part of the device.

FIG. 3B shows a device as shown in FIG. 3A in an extended state. The housing 330 may be include a frame around the entire edge of the device, or the housing 330 may be completely occluded by the flexible display 310 so that none of the housing 330 is visible when viewing the display 310 as previously described. In some configurations, the flexible display 310 may cover a portion of one side of the housing 330 when the display 310 is in the collapsed state and expose the portion of that side of the housing 330 when the display 310 is in the extended state. For example, in an example as illustrated in FIGS. 3A-3B, the device may be folded in thirds as shown, with about the right third of the device shown in FIG. 3B folded behind the device, and about the left third of the device folded behind the folded right third, to result in the configuration shown in FIG. 3A. In this example, the rear portion of the housing as well as the right third of the display may not be visible from the rear of the device.

The active portion of the display 310 in the example shown in FIG. 3A is approximately one-third the size of the active portion of the display 310 in FIG. 3B. For example, in the collapsed state, the device may have the form factor of a smartphone or cellular phone while having the form factor of a tablet in the extended state. In some configurations the device may be operable by a single hand, such that substantially the entire viewable area is touchable by the thumb of a user, when in the collapsed state. In the extended state, the device may require two hands of a user to hold and operate it. The specific form factor and dimensions shown in FIGS. 3A-3B are illustrative only and, in general, any desired size and/or form factor may be used.

The display 310 may be active, i.e., configured to emit light, on one side of the device in FIG. 3A, or the display 310 may be active on both the front 312 and back 314 side of the device. For example, the device may contain a hardware and/or software toggle switch to activate the back (or second) 314 side display. Similarly, a switch or other mechanism may be used to determine when the device is placed into a collapsed configuration as described in further detail below, at which point various portions of the display may be made active or inactive, or the orientation of some or all of the display may be changed based upon the configuration. The flexible display 310 may be constructed using an active matrix backplane, an OLED display, a touch sensitive display, or combinations thereof. The touch sensitive surface may be smaller when the flexible display 310 is in the collapsed state than when it is in the expanded state. For example, a processor may not register touches to the screen on an inactive portion of the display, such as the back side of the device illustrated in FIG. 3B. Similarly, if both the front 312 and the back 314 portions of the display that are exposed are in use, touches may be registered by the processor for both surfaces.

A sensor may be incorporated into the display or housing of the device that allows it to detect when the device is in the collapsed or the extended state. The sensor may provide an indication of the state of the device to a processor. An electronic flexible display state switch may indicate the state of the electronic flexible display. For example the device may have a light sensor that, upon detecting a light level below a specified threshold, determines that the device is in a folded conformation. A sensor may detect the degree of bend at one or more hinges 320 and determine the configuration of the screen 310 or device based on the bend detected in one or more hinges 320. The processor may also change the orientation of an image displayed on the flexible display 310 based on a changed detected in the configuration of the device. For example, a picture viewed in landscape orientation in the collapsed state shown in FIG. 3A may require a change to a portrait orientation if the screen 310 is unfolded into the extended state shown in FIG. 3B without changing hand position. Similarly a portrait image in the collapsed state could change to a landscape image in the extended state.

In some cases various portions of the display may be used to perform different functions depending upon the physical configuration of the device. For example, in a configuration as shown in FIG. 3A, the front portion 312 of the display may be used as a general-purpose display, such as to display a user interface for a cellular phone, mobile applications, and the like, and the back portion 314 of the display may be usable for general-purpose illumination, such as by emitting white light. The functionality may be controllable by a user and/or software on the device, such as where a user can activate the general-purpose illumination portion of the screen to use as a flashlight or similar light source. The specific functions described are provided as illustrations only, and more generally any functionality may be assigned to any portion of the flexible display when in any configuration.

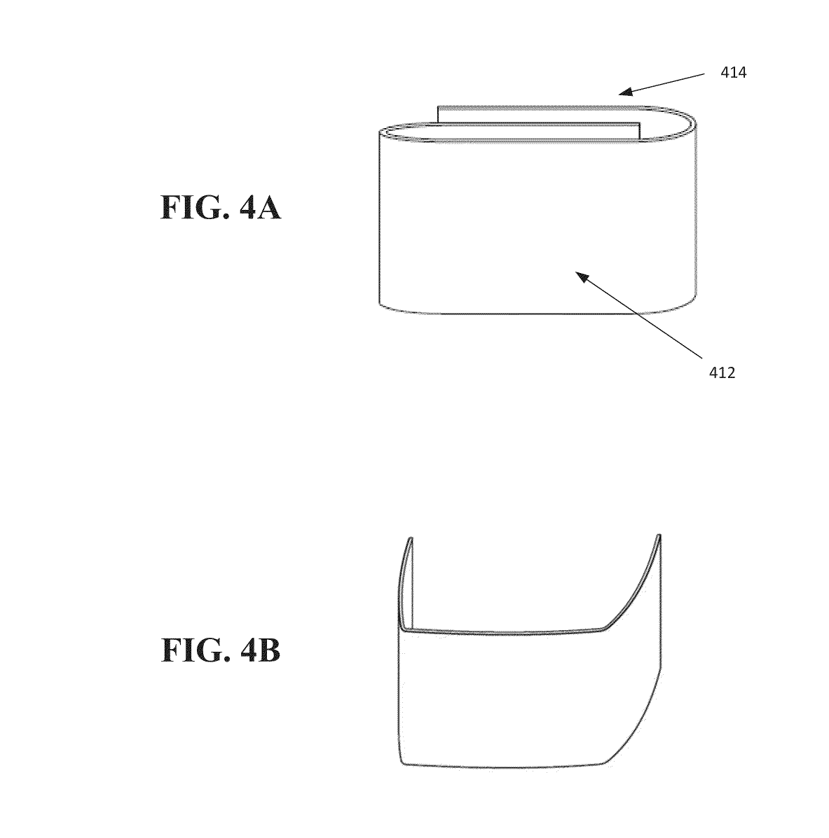

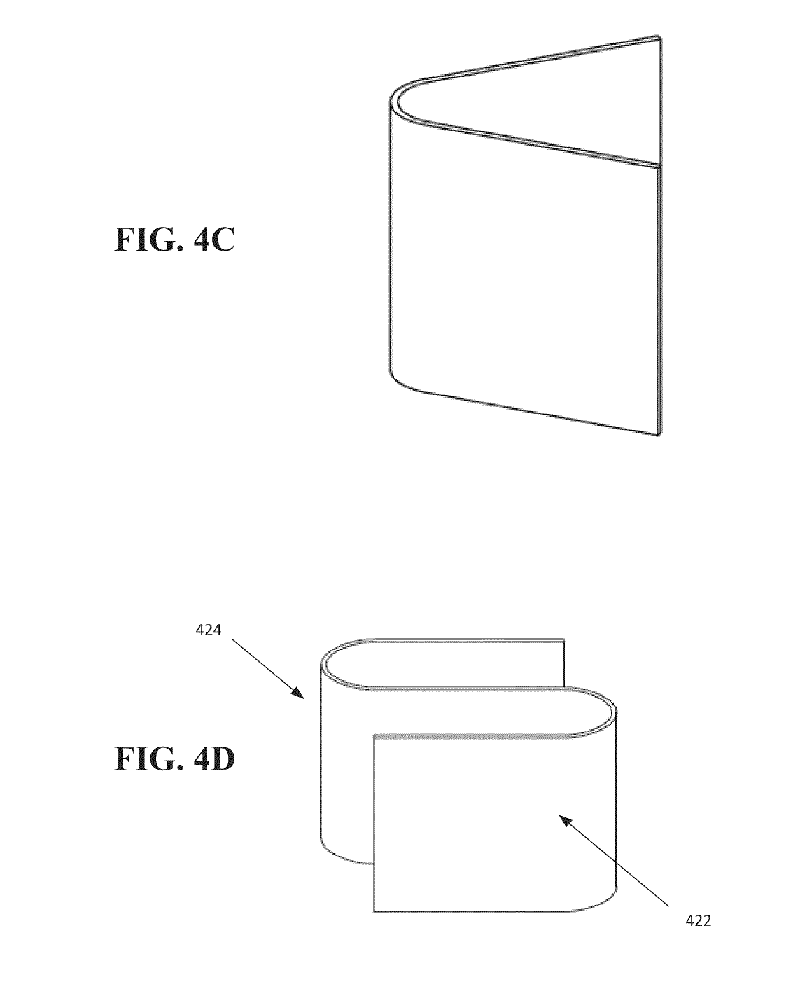

The flexible display may be arranged in a variety of configurations including those shown in FIGS. 3A and 3B. FIG. 4A is a top-down view of the flexible display in a conformation similar to the tri-folded device shown in FIG. 3A. The device may be substantially “U” shaped in the collapsed state and have a top side 412 and a bottom 414 side. The top side 412 may be configured to emit light and the bottom side 414 may be configured to be disabled. As described earlier, a device orientation switch or similar mechanism may cause the device to respond to the rotation of the U-shaped flexible display in a horizontal axis and indicate to a processor to flow or send display data from the top side of the U-shaped flexible display toward the bottom side of the U-shaped display as the device or display is rotated. The device orientation switch may also respond to rotation of the U-shaped flexible display in a vertical axis and indicate to the processor to switch the active flexible display from the top side of the device to the bottom side as the U-shaped flexible display is rotated, and/or as the display is manipulated from an expanded configuration as in FIG. 3B to the collapsed configuration in FIG. 4A. FIG. 4B is an angled view of a tri-folded device that has been locked into a “C” shape. FIG. 4C is a bi-folded conformation which may have a hinge at the bend on the top and bottom of the display. The device may have a flexible display on each side that may be activated. For example, FIG. 4D shows another potential conformation of a tri-folded device that can have an active display on the front side 422 and the back side 424 of the device. The first display in FIG. 4A includes the second display, that is a single side of the display has been folded over and provides an image on the front side 412 and back side 414 of the device. However, in FIG. 4D, the first and second display may be physically distinct, optionally separated by a housing or other framework. Other configurations may be possible besides those shown in FIGS. 4A-D.

The housing or frame may include a series of ribs that may be attached directly or indirectly to the flexible display. The ribs may be configured to maintain the flexible display in various conformations that range from a completely flat shape to forming an “S” shape or “O” shape. Various materials may be used to form the ribs such as plastic, aluminum, or titanium. The ribs may be substantially parallel and allow the flexible display to flex in a direction substantially perpendicular to the ribs. For example, they may be attached to the back of a flexible display to limit the display's flexibility in a horizontal direction. For example, a first configuration may include where the flexible screen is rolled or curved inside a housing such as that offered by a pen, a smartphone, a tablet, or the like. Stiffening elements may be physically connected to the ribs which, when activated, maintain the ribs in a particular configuration. For example, a flexible screen rolled into a housing such as a pen or smartphone may be automatically or manually extended into a substantially flat configuration. Examples of stiffening elements include motorized arms, motorized rods, rotating pins, pneumatic bladders, and electromagnets. The stiffening elements may be disposed between each pair of adjacent ribs, affixed to the back side of ribs, arrayed in a staggered pattern between ribs, or the like. A sensor may be located in the bottom of one or more of the ribs that automatically adjust the degree of each bend of the flexible display. In a specific example, a set of ribs may be arranged vertically relative to the display, and each rib may include one or more segments that can be rotated to be substantially perpendicular to the initial configuration of the rib. When rotated, the ribs may provide horizontal rigidity to the display, thus preventing it from flexing in the horizontal direction. When arranged in line with the remainder of the rib, the segments may not prevent flexing in the horizontal direction, thus allowing the display to be folded, rolled, or otherwise flexed in the horizontal direction. In some configurations, only a portion of a device may include rigid ribs connected to the flexible display. For example, in the configuration shown in FIGS. 3A-3B, only portions of the screen in the region near the bendable portions of the display may be connected to rigid ribs. Additional information on the construction and use of rigid ribs with a flexible display is provided in co-pending U.S. application Ser. No. ______, Docket No. UDC-827US, the disclosure of which is incorporated by reference in its entirety.

In some configurations the flexible display may be rollable, that is, it may be wound more than one complete revolution upon itself. For example, the extended portion of the display may fold or roll up inside a base unit and then unfold or unroll for tablet-like operation. The rollable, flexible display may be a component of a device with a second display that is physically distinct from the flexible display. When in the extended state, the flexible display may be addressable such that it may provide an extension of the second display. For example, a smartphone may contain a rigid screen representing the second display and a flexible display that may be unrolled from the smartphone housing representing a first display. The flexible display may be supported by a frame or housing that can be extended from the smartphone. The second display may communicate with hardware on the smartphone to allow for display data to be processed, transmitted, and received from the flexible display by hardware of the device. When acting as an additional display for a device, the flexible display may also be touch sensitive. It may be configured to display content different from or unrelated to that of the second display. The first display may be capable of receiving input from a user or third party device that is assigned to it (such as a mouse, keyboard, web camera, printer, etc.) and distinct from the activity occurring on the second display and/or third party devices connected to the second display. An advantage of having the first display capable of operating independent of the second is that a second user may be able to interact with the device independent of a first user.

The flexible display may be constructed from one or more OLEDs such as phosphorescent OLEDs. For example, a display may be a flexible, active-matrix display and include OLEDs deposited onto a flexible active-matrix backplane that includes thing-film transistors (“TFTs”) associated with the OLEDs. The flexible display may have a minimum resolution of 160 dpi, 200 dpi, 300 dpi, 400 dpi, or more. In some configurations, the portion of the total flexible display that is utilized when the display is in the collapsed or extended state may be predefined by software. For example, the device shown in FIG. 3A may have a preset screen resolution when the device is in a tri-folded collapsed configuration. In another configuration, where the flexible display may be folded at any point along the length of the display, a sensor may detect where bends in the screen have occurred and determine a suitable viewable screen resolution based on the determination of where the bends have occurred. Alternatively or in addition, a user may define the resolution or viewable screen using software on the device. For example, a user may launch an interface that instructs a user to tap the desired surfaces. A user may tap the front side 412 and back side 414 of the device shown in FIG. 4A to indicate that the user desires to have the display activated on both the front 412 and back 414 side of the device. The interface may then allow the user to configure the resolution of each of the desired screens or the device may determine the appropriate resolution for the front 412 and back 414 side displays.

Devices as disclosed herein may include a variety of additional components, such as a wireless transmitter (e.g., cellular radio, wireless transceiver), a processor, computer readable storage, and the like. Such components may allow the device to operate as a cellular phone, a wireless network node, and the like in at least one configuration. In some cases a component may be disabled in one of the configurations, such as where the device only operates as a cellular telephone when configured in an appropriate form factor. Such configurations may be desirable, for example, to allow for various power saving modes during operation of the device. In other configurations, each component may be functional in each configuration of the device, and/or the operation of various components may be set by a user of the device, a power profile or other policy stored within the device, or the like.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

1. A device, comprising:
a flexible display having an extended state and a collapsed state, wherein the flexible display has a first viewable area when configured in the extended state and a second viewable area when configured in the collapsed state, the second viewable area being smaller than the first viewable area.

2. The device as recited in claim 1, wherein the flexible display comprises a touch sensitive surface.

3. The device as recited in claim 2, wherein the area of the touch sensitive surface is smaller when the flexible display is in the collapsed state than when the flexible display is in the extended state.

4. The device as recited in claim 1, further comprising a sensor configured to detect the configuration of the device.

5. The device as recited in claim 4, wherein the sensor provides an indication of the state of the device to a processor.

6. The device as recited in claim 5, wherein the processor is configured to change the orientation of an image displayed on the flexible display based upon detecting a change in the configuration of the device.

7. The device as recited in claim 1, further comprising:
an electronic flexible display state switch indicating the state of the electronic flexible display.

8. The device as recited in claim 1, further comprising a housing, wherein the flexible display covers a portion of a first side of the housing when the flexible display is in the collapsed state, and exposes the portion of the first side of the housing when the flexible display is in the extended state.

9. The device as recited in claim 1, wherein the first viewable area comprises the second viewing area.

10. The device as recited in claim 1, wherein the device has a form factor of a smartphone when the flexible display is in the collapsed state.

11. The device as recited in claim 1, wherein the device has a form factor of a tablet device when the flexible display is in the extended state.

12. The device as recited in claim 1, wherein the device is configured to be held and operated with a single hand of a user when the flexible display is in the collapsed state.

13. The device as recited in claim 12, wherein substantially the entire second viewable area is touchable by the thumb of the user when the device is held in the single hand.

14. The device as recited in claim 1, wherein the device is configured to be held and operated with two hands of a user when the flexible display is in the extended state.

15. The device as recited in claim 1, wherein the device is configured to be held and operated with a single hand of a user when the flexible display is in the collapsed state, and held and operated with two hands of a user when the flexible display is in the extended state.

16. The device as recited in claim 1, wherein the flexible display is configured to form a substantially U-shaped flexible display in the collapsed state, the U-shaped flexible display having a top side and a bottom side.

17. The device as recited in claim 16, wherein the top side of the U-shaped flexible display is configured to emit light and the bottom side is disabled.

18. The device as recited in claim 16, further comprising:
a device orientation switch configured to respond to rotation of the U-shaped flexible display in a horizontal axis, and indicate to a processor to flow flexible display data from the top side of the U-shaped flexible display toward the bottom side of the U-shaped flexible display as the U-shaped flexible display is rotated.

19. The device as recited in claim 18, wherein the device orientation switch is further configured to respond to rotation of the U-shaped flexible display in a vertical axis, and to indicate to the processor to switch the active flexible display from the top side of the U-shaped to the bottom side as the U-shaped flexible display is rotated.

20. The device as recited in claim 1, wherein the flexible display comprises a rollable display.

21. The device as recited in claim 20, wherein the device comprises a cellular telephone.

22. The device as recited in claim 21, wherein the device comprises a second display, physically distinct from the flexible display.

23. The device as recited in claim 22, wherein, when disposed in the extended state, the flexible display is addressable to provide an extension of the second display.

24. The device as recited in claim 1, wherein the flexible display comprises an OLED.

25. The device as recited in claim 1, further comprising a thin film encapsulation layer disposed over or under the OLED.

26. The device as recited in claim 1, wherein the flexible display comprises a phosphorescent OLED.

27. The device as recited in claim 1, further comprising a wireless transmitter.

28. The device as recited in claim 1, wherein the flexible display has a minimum resolution selected from the group consisting of: 160 dpi, 200 dpi, 300 dpi, and 400 dpi.

29. The device as recited in claim 1, wherein the device comprises an active matrix backplane.
